(19) United States
(12) Patent Application Publication
(10) Pub. No.: US 2023/0070054 A1
(43) Pub. Date: Mar. 9, 2023

(54) NEEDLE FOR USE IN ANALYTICAL APPLICATION

(71) Applicant: Dionex Softron GmbH, Germering (DE)

(72) Inventors: Michael KOLBE, Germering (DE); Christoph HOLLNAGEL, Germering (DE); Hermann HOCHGRAEBER, Germering (DE); Robert SPRINGER, Germering (DE)

(21) Appl. No.: 17/929,940

(22) Filed: Sep. 6, 2022

(30) Foreign Application Priority Data
Sep. 6, 2021 (DE) 10 2021 122 999.5

(51) Int. Cl. G01N 30/24; B01D 15/20

(52) U.S. Cl. CPC G01N 30/24; B01D 15/206; G01N 2030/027

(57) ABSTRACT

The present invention relates to a needle (1), wherein the needle (1) comprises a channel (12) extending through the needle (1), wherein the needle (1) comprises a needle tip (11), wherein the channel (12) comprises an opening at the needle tip (11), wherein the needle (1) defines an axial direction (x), wherein the axial direction (x) defines a distal direction and a proximal direction, wherein the needle tip (11) is a distal portion of the needle (1), and wherein the needle tip (11) comprises a first surface section (112) and a second surface section (111), wherein the first surface section (112) is arranged at a first angle (α) with respect to the axial direction (x) and the second surface section (111) is arranged at a second angle (β) with respect to the axial direction (x), wherein the first angle is different from the second angle. The present invention also relates to a corresponding apparatus, system and use.

### CROSS-REFERENCE TO RELATED APPLICATION

This application claims the priority benefit under 35 U.S.C. § 119 to German Patent Application No. DE 10 2020 1122999.5 [Attorney Docket No. TP109200PRI1], filed on Aug. 25, 2022, the disclosure of which is incorporated herein by reference.

### FIELD OF INVENTION

The present invention generally relates to a needle, and more particularly to a hollow needle, i.e., a needle comprising a channel running through the needle. While the needle will be primarily described with regard to its application in analytical devices, e.g., in chromatography apparatuses, it should be understood that the needle may also be employed in other fields. The present invention also relates to apparatuses and systems comprising the needle, and to the use of the needle.

### BACKGROUND OF THE INVENTION

According to the general state of the art, different cannulas/hollow needles are used in HPLC for taking and delivering liquid samples from different sample containers.

Generally, beveled but also completely flat (“blunt”) cannulas/hollow needles are in use in the field of HPLC.

One problem associated with the prior art hollow needle is that they may punch out material, e.g., from a septum. With regard to sample collection and delivery, such punching out of the cover material can occur when piercing the cover of the sample container, which may be problematic. In particular, cannulas/hollow needles with flat (“blunt”) tips or end faces are more likely to punch out, leading to problems such as blockages in the fluidic paths.

This problem occurs much less frequently with cannulas/hollow needles with beveled tips. However, cannulas/hollow needles shaped in this way have clear disadvantages during bottom detection. Bottom detection, also referred to as bottom sensing, describes the process of the needle going down until contacting the bottom of the sample container with a test force that is higher than the friction of the septum. During such bottom detection, needles with a beveled tip may undergo formation of plastic, i.e. irreversible, deformations (material accumulations; bulge formations) at the first mechanical point of contact, i.e., the point that touches the sample container to perform the bottom sensing test force because the elastic deformation range of the material around the contact point of the container bottom is exceeded. This contacting point may be, e.g., the foremost point of the tip of the cannula/hollow needle. Especially at beveled cannulas/hollow needles, plastic deformations occur frequently, rapidly and in an undefined manner. For example, relatively small plastic deformations resulting from many different shaped contact partners steadily accumulate to a finally problematic deformation. This may causes damage and/or, as a consequence, contamination (e.g. particles) at complementary contact partners (e.g. sealing surfaces). That is, punching out cover material when piercing the cover of the sample container is a problem and risk that can be significantly reduced by beveled tips on the cannula/hollow needle.

Cannulas/hollow needles with flat tips/face surfaces may exhibit better behavior in terms of plastic deformation. That is, to avoid plastic deformation, a flattened end face over much or all of the cross-section of the tip of the cannula/hollow needle may be used. Again, this may be associated with the known disadvantage of punching out the cover material of sample container. Furthermore, some prior art apparatuses may also use technologies to detect the bottom of a container containing a sample to be picked up.

Furthermore, such needles may also comprise a coating. However, in addition to the deformations discussed above, the needle (in particular needles with an angled surface) contacting a bottom of a container may result in delamination of the coating. In particular, local delamination of coatings at the tip of the cannula/hollow needle during tactile contact (e.g. with the bottom of the sample container) may occur.

Overall, these problems and disadvantages result in significant reductions in the performance (efficiency and robustness) and lifetime of the individual components and the entire system.

### SUMMARY OF THE INVENTION

It is therefore an object of the present invention to overcome or at least reduce the shortcomings and disadvantages of the prior art. In particular, it is an object of the present invention to provide a hollow needle, e.g., for use in HPLC applications, having improved characteristics with regard to the stated problems.

These objects are met by the present invention.

According to a first aspect, the present invention relates to a needle. The needle comprises a channel extending through the needle. The needle also comprises a needle tip and the channel comprises an opening at the needle tip. That is, the channel is connected to ambient at the needle tip, and it will be understood that this also encompasses the channel being connect to a needle seat in case the needle is located in such a needle seat. The needle also defines an axial direction, and the axial direction defines a distal direction and a proximal direction. The needle tip is a distal portion of the needle. The needle tip comprises a first surface section and a second surface section. The first surface section is arranged at a first angle with respect to the axial direction, and the second surface section is arranged at a second angle with respect to the axial direction, wherein the first angle is different to the second angle.

It will be understood that the needle tip is more distal than other portions of the needle.

In particular, the first surface section may be (at least substantially) orthogonal with respect to the axial direction, i.e., a normal vector of the first surface section may be (at least substantially) parallel to the axial direction, while a normal vector of the second surface section may be at a greater angle with respect to the axial direction. Thus, there may be an orthogonal section (which may also be referred to as blunt section) and an angled section.

Such a needle may realize different advantages.

In particular, the problem of punching out the cover material of a sample container may be overcome. More particularly, by the forward end of the needle tip not only comprising a blunt section, but another angled section, the risk of cover material (e.g., of a septum) being punched out may be strongly reduced. Furthermore, by still having different sections with different angles (e.g., a section being at least substantially orthogonal to the axial direction, i.e., flat tips/face surfaces), such a needle may be less prone to plastic deformation and layer delamination in case a coating is used. Thus, efficiency and robustness of the needle (systems comprising the needle) may be improved.

That is, embodiments of the present invention may be improved as regards avoidance of plastic deformations as well as the delaminations (in case a coating is used at the tip of the needle) vis-à-vis beveled cannula/hollow needle (without plane front surface), e.g., during bottom detection (e.g. of sample container) and/or tactile contact partners (e.g. seal seat). Embodiments of the present technology thus relate to an optimized geometry for the tip of the cannula/hollow needle to solve or at least alleviate the discussed problems. It will be understood that embodiments of the present invention also relate to apparatuses comprising a bottom detection mechanism. Overall, these embodiments lead to improvements of efficiency and robustness by reducing sources of error (e.g., material punching, and layer delamination).

More particularly, in embodiments of the present technology, different geometries of the respective beveled and the flat (“blunt”) tip are combined and the relationship of the geometries to each other (flat surface and bevel) as well as the interfaces (chamfer, rounding) between the geometries are matched and optimized. In addition, the application and distribution of the coating may be changed. All adjustments may be implemented using suitable manufacturing processes.

In still other words, embodiments of the invention relate to the adaptation and proportionate combination of different geometries at the tip of the cannula/hollow needle, which in principle may comprise a beveled and flat end face. Embodiments thus combine the advantages of each geometry in terms of avoiding the punching out of the cover material, which avoidance is achieved by the beveled portion, and reducing wear and deformation during the bottom detection of the sample containers by the flat front surface of the cannula/hollow needle.

It will be understood that the discussed technology may be adapted to pierce the cover (septum) from a sample container (vial, well plate) to reach the contained sample. Furthermore, it may also allow for bottom detection on the sample container to thus allow the sample to be picked up (at least almost) completely without loss from the correct, predetermined needle tip height over the container bottom. These functionalities can be met by embodiments of the present technology.

Overall, with embodiments of the present technology, the occurrence of plastic deformations and/or the way in which they occur, as well as the punching out of covering material of the sample containers, may be overcome, and embodiments of the present technology may thus combine advantageous technical effects in one needle design, which may increase efficiency and robustness of its applications.

Embodiments relate to the ratio of the size and arrangement of the geometries with respect to the features (e.g. inner opening) of the cannula/hollow needle. In addition, the design of the interfaces or transitions between the geometries and the implementation of keeping the tip of the cannula/hollow needle free of coatings (or having a different coating depending on its location) form embodiments of the present invention.

The channel may be parallel to the axial direction.

The first angle may be in the range of 85° to 95°, further preferably 87° to 93°, still further preferably 89° to 91°.

That is, the first surface section may be at least approximately at a right angle with respect to the axial direction.

In still other words, a vector normal to the first surface section, which may also be referred as a first vector, may form a first normal angle with the axial direction, and the first normal angle may be in the range to −5° to 5°, preferably −3° to 3°, further preferably −1° to 1°.

The second angle may be in the range of 96° to 160°, preferably 100° to 140°, further preferably 110° to 130°.

In other words, a vector normal to second surface section, which may also be referred as a second vector, may form a second normal angle with the axial direction, and the second normal angle may be in the range to 6° to 70°, preferably 10° to 50°, further preferably 20° to 40°.

The first surface section may be the most distal portion of the needle.

The first surface section may form a plane.

The second surface section may form a plane.

The first surface section may comprise a border forming a straight line.

The second surface section may comprise a border forming a straight line.

The first surface section may be a single connected portion.

The first surface section may comprise a plurality of portions.

The needle may be mirror symmetric about a first symmetry plane parallel to the axial direction.

The needle may be mirror symmetric about a second symmetry plane parallel to the axial direction and orthogonal to the second symmetry plane.

The first surface section may comprise an area and this area may be such that during bottom detection, the mechanical tension is smaller than a yield point of the material to avoid large and/or critical plastic deformations.

The needle may be configured to withstand a fluid pressure exceeding 10 bar, preferably exceeding 100 bar, further preferably exceeding 500 bar, in the channel.

It will be understood that the needle is also configured to operate at lower pressures, e.g., at atmospheric pressure.

The opening of the channel may lie, at least in part, in the plane formed by the first surface section.

The opening of the channel may lie, at least in part, in the plane formed by the second surface section.

The opening of the channel may lie wholly in the plane formed by the second surface section.

A ratio of the area of the opening of the channel lying in the plane formed by the first surface section to the area of the opening of the channel lying in the plane formed by the second surface section may be in the range 0.2 to 0.8, preferably 0.3 to 0.7, further preferably 0.4 to 0.6.

An intersection between a projection of the opening of the channel onto a plane orthogonal to the axial direction and a projection of the first surface section onto the same plane may comprise a first area.

An intersection between a projection of the opening of the channel onto a plane orthogonal to the axial direction and a projection of the second surface section onto the same plane may comprise a second area.

A ratio between the first area and the second area may be in the range of 0.1 to 10, preferably 0.2 to 5, further preferably 0.3 to 1.5, such as 0.25 to 0.75.

The needle may comprise at least one transition section.

The needle may comprise a plurality of transition sections.

The needle tip may comprise a surface transition section connecting the first surface section and the second surface section.

The needle tip may comprise an inner transition section connecting the first surface section and/or the second surface section to the channel.

The inner transition section may also connect the surface transition section to the channel.

The needle tip may further comprise an outer lateral surface.

The needle tip may comprise an outer transition section connecting the first surface section and/or the second surface section to the outer lateral surface.

The outer transition section may connect the surface transition section to the outer lateral surface.

Any of the at least one transition section may comprise a chamfer.

The inner transition section may comprise a chamfer.

The outer transition section may comprise a chamfer.

Any of the at least one transition section may comprise a rounding.

The inner transition section may comprise a rounding.

The outer transition section may comprise a rounding.

The needle may be covered, at least in part, with a coating. In other words, the needle may also comprise at least one coating, and the at least one coating may expand and improve functions of the needle. The coating may adapt the surface properties, e.g., to improve chemical (e.g. resistance) and mechanical properties (e.g. abrasion). The application of one or more coatings may also serve to reduce friction and/or the resulting abrasion.

The coating may be configured to reduce an interaction between the needle and its ambient.

The coating may cover, at least in part, the needle tip.

The coating may comprise a uniform coating such that a thickness of the coating is significantly identical at each coated location of the needle.

The uniform thickness may be in the range of 1.0 to 5.0 μm, preferably 2.0 to 4.0 μm, further preferably 2.5 to 3.5 μm.

The coating may comprise a non-uniform coating such that a thickness of the coating varies between coated locations of the needle.

A minimum thickness of the coating may be in the range of 0.1 μm to 2.0 μm, preferably 0.25 to 1 μm.

A maximum thickness of the coating may be in the range of 4.0 to 7.0 μm, preferably 5.0 to 6.0 μm.

The most distal portion of the needle may not comprise a coating. In particular, the first surface section may be coating free. Thus, delamination of the coating may be avoided or strongly reduced. It will be understood that in case coatings are used, different loads (e.g., mechanical loads) and resulting stresses may typically often lead to delamination and thus also to damage and contamination. This may be eliminated and/or reduce by the most distal portion of the needle not comprising the coating, i.e., being coating free.

The coating may comprise a single material in all coated location of the needle.

The coating may comprise a plurality of materials such that each of the plurality of materials is applied to a different portion of the needle.

The coating may comprise diamond like carbon (DLC), preferably fluorine-containing diamond like carbon (F-DLC), titanium nitride (TiN), and/or silicon carbide (SiC). Silicon carbid may be used, e.g., as a bonding agent layer.

The needle may be configured to detect a bottom of a container.

The needle tip, preferably the first surface section of the needle tip, may be configured to detect the bottom of a container.

The needle may be formed of a metal, preferably a metal allow, such as stainless steel, preferably 1.4404, 1.4435, and/or 1.4571 stainless steel, MP35N, or titanium, preferably titanium grade 2 or grade 5; and/or a ceramic, e.g., sapphire, ruby, and/or zirconium.

A length (L) of the needle may be in the range of 30 mm to 150 mm, preferably 50 mm to 100 mm.

A diameter (D) of the needle may be in the range of 0.1 mm to 5 mm, preferably 0.1 mm to 3 mm.

A diameter (d) of the channel may be in the range of 0.05 mm to 1.0 mm, preferably 0.05 mm to 0.5 mm.

In another aspect, the present invention also relates to an apparatus comprising the needle.

The apparatus may be a sampler for liquid samples. It will thus be understood that embodiments of the present technology relate to the area(s) of automatic sample acquisition and delivery (injection), in particular in an “autosampler” module of an analysis system. Embodiments thus cover an important application step in High Performance Liquid Chromatography (HPLC). The embodiments may serve both to improve existing functions and to expand them with new functions.

Overall, with the present technology, e.g., the injection process may be performed with an increased efficiency and robustness. This may be beneficial with regard to increased efficiency in sample collection in terms of the amount or volume of residual sample remaining in the sample container, i.e., it may be improved with regard to collection the entire sample volume without losses. In particular, embodiments of the present technology may also allow for detection the bottom of the sample container.

The apparatus may be a fractioning apparatus for fractioning liquids.

The needle may be used in HPLC applications, e.g., for sample acquisition, but also for sample delivery. The needle may also be used in the process of sample fractionation (partitioning), where the described advantages are also beneficial.

In still another aspect, the present invention also relates to an analytical system comprising the needle or the apparatus.

The analytical system may be a liquid chromatography system and preferably a high performance liquid chromatography system.

In a still further aspect, the present invention also relates to an use of the needle, the apparatus, or the system, wherein the use comprises supplying a fluid to the channel.

The use may comprise supplying the fluid with a pressure exceeding 10 bar, preferably exceeding 100 bar, further preferably exceeding 500 bar to the channel.

That is, the fluid in the channel may be at a pressure exceeding the above mentioned pressures.

The use may be in an analytical procedure.

The analytical procedure may be liquid chromatography, and preferably high performance liquid chromatography.

Advantages of the invention relate in the combination of the aforementioned geometries (bevel; flat face), which also allows the respective advantages (piercing without punch outs; bottom detection without tip deformation) of these variants to be combined, which is not possible if only providing a beveled or a flat surface.

The use of a beveled face on the tip of the cannula/hollow needle, as described in detail previously, allows piercing of the sample container cover without punching out of the material. In combination with the flat face, the same cannula/hollow needle and in the same step allows the bottom detection of the sample container without risking major plastic deformations at the tip, which would result in damage and contamination.

Embodiments of the invention thus relate to modifications to the geometry of the tip of the needle, which may be used, e.g., for sample collection and delivery in HPLC. The (injection) needle is a hollow needle and may also be referred to as cannula.

In still other words, embodiments of the present technology relate to a cannula/hollow needle with an advanced tip geometry. The needle may also comprise a coating. Embodiments of the present technology may achieve at least one (and preferably all) of the following advantages: piercing the covers of sample containers without creating punch-outs and blockages; bottom detection of sample containers without critical plastic deformations and the formation of material accumulations (bulge formation) at the tip; avoidance of consequential damage to complementary contact surfaces in the event of critical plastic deformation at the tip; avoidance of layer delamination at the tip during tactile contact.

The present technology may also relate to a method for detecting the bottom of sample containers in an autosampler in HPLC, wherein the method uses the discussed needle.

Generally, it will be understood that embodiments of the present technology relate to a particularly adjusted tip geometry of the needle to avoid clogging due to punch outs and to allow bottom detection.

More particularly, the geometries at the tip of the cannula/hollow needle may be adjusted to enable the functions of bottom detection with/without coating without damage and also to avoid the generation of punch-outs from the cover material of sample containers.

Furthermore, as described, the geometries may be further fine-tuned to each other and in relation to the basic geometry (inner opening) of the cannula/hollow needle. This allows additional functions to be optimized, such as complete and residue-free sample collection from the sample container.

The transitions/interfaces between the geometries may be provided with chamfers and roundings. This may also improve the functionality, such as avoiding the generation of punch-outs due to sharp-edged geometries. In particular, the chamfers and roundings to the outer sheath geometry at the tip of the cannula/hollow needle may avoid negative effects such as damage and contamination due to plastic deformations (material accumulation, bulge formation) at the end face.

As discussed, in embodiments, at least a portion of the tip of the cannula/hollow needle may kept free of the coating locally. This may enable tactile contact without delamination of the coating and subsequent damage and contamination to the components or contact partners due to the damages occurring, e.g., due to sharp edges, e.g., at broken coating layer portions.

Overall, advantages of the invention may be based on the usability of different functionalities, which are combined by the adaptations in one part and offer higher efficiency and robustness. Overall, embodiments of the present invention may thus lead to a reduction of error sources and error frequencies. In addition, the effort in production and use can be reduced and the system performance can be increased, since both main functions and further improvements may be combined in one component.

Embodiments of the present technology thus increase robustness, reproducibility, as well as the avoidance of and resistance to malfunctions and sources of error.

The present invention is also defined by the following numbered embodiments.

Below, needle embodiments will be discussed. These embodiments are abbreviated by the letter “N” followed by a number. Whenever reference is herein made to needle embodiments, these embodiments are meant.

N1. A needle (1),

wherein the needle (1) comprises a channel (12) extending through the needle (1),

wherein the needle (1) comprises a needle tip (11), wherein the channel (12) comprises an opening at the needle tip (11),

wherein the needle (1) defines an axial direction (x), wherein the axial direction (x) defines a distal direction and a proximal direction, wherein the needle tip (11) is a distal portion of the needle (1), and

wherein the needle tip (11) comprises a first surface section (112) and a second surface section (111), wherein the first surface section (112) is arranged at a first angle (α) with respect to the axial direction (x) and the second surface section (111) is arranged at a second angle (β) with respect to the axial direction (x), wherein the first angle is different from the second angle.

It will be understood that the needle tip is more distal than other portions of the needle.

N2. The needle (1) according to the preceding embodiment, wherein the channel (12) is parallel to the axial direction (x).

N3. The needle (1) according to any of the preceding embodiments,

wherein the first angle is in the range of 85° to 95°, further preferably 87° to 93°, still further preferably 89° to 91°.

That is, the first surface section may be at least approximately at a right angle with respect to the axial direction.

In still other words, a vector normal to the first surface section, which may also be referred as a first vector, may form a first normal angle with the axial direction, and the first normal angle may be in the range to −5° to 5°, preferably −3° to 3°, further preferably −1° to 1°.

N4. The needle according to any of the preceding embodiments,

wherein the second angle is in the range of 96° to 160°, preferably 100° to 140°, further preferably 110° to 130°.

In other words, a vector normal to second surface section, which may also be referred as a second vector, may form a second normal angle with the axial direction, and the second normal angle may be in the range to 6° to 70°, preferably 10° to 50°, further preferably 20° to 40°.

N5. The needle (1) according to any of the preceding embodiments, wherein the first surface section (112) is the most distal portion of the needle (1).

N6. The needle (1) according to any of the preceding embodiments, wherein the first surface section (112) forms a plane.

N7. The needle (1) according to any of the preceding embodiments, wherein the second surface section (111) forms a plane.

N8. The needle (1) according to any of the preceding embodiments, wherein the first surface section (112) comprises a border forming a straight line.

N9. The needle (1) according to any of the preceding embodiments, wherein the second surface section (111) comprises a border forming a straight line.

N10. The needle (1) according to any of the preceding embodiments, wherein the first surface section (112) is a single connected portion.

N11. The needle (1) according to any of the embodiments N1 to N9, wherein the first surface section (112) comprises a plurality of portions.

N12. The needle (1) according to any of the preceding embodiments, wherein the needle (1) is mirror symmetric about a first symmetry plane parallel to the axial direction.

N13. The needle (1) according to the preceding embodiment, wherein the needle (1) is mirror symmetric about a second symmetry plane parallel to the axial direction and orthogonal to the second symmetry plane.

N14. The needle (1) according to any of the preceding embodiments, wherein the needle (1) is configured to withstand a fluid pressure exceeding 10 bar, preferably exceeding 100 bar, further preferably exceeding 500 bar, in the channel (12)

It will be understood that the needle is also configured to operate at lower pressures, e.g., at atmospheric pressure.

N15. The needle (1) according to any of the preceding embodiments and with the features of embodiment N7, wherein the opening of the channel (12) lies, at least in part, in the plane formed by the first surface section (112).

N16. The needle (1) according to any of the preceding embodiments and with the features of embodiment N8, wherein the opening of the channel (12) lies, at least in part, in the plane formed by the second surface section (111).

N17. The needle (1) according to the preceding embodiment and without the features of the penultimate embodiment, wherein the opening of the channel (12) lies wholly in the plane formed by the second surface section (111).

N18. The needle (1) according to embodiment N16 and with the features of embodiment N16, wherein a ratio of the area of the opening of the channel (12) lying in the plane formed by the first surface section (112) to the area of the opening of the channel (12) lying in the plane formed by the second surface section (111) is in the range 0.2 to 0.8, preferably 0.3 to 0.7, further preferably 0.4 to 0.6.

N19. The needle (1) according to any of the preceding embodiments, wherein an intersection between a projection of the opening of the channel (12) onto a plane orthogonal to the axial direction and a projection of the first surface section (112) onto the same plane comprises a first area.

N20. The needle (1) according to any of the preceding embodiments, wherein an intersection between a projection of the opening of the channel (12) onto a plane orthogonal to the axial direction and a projection of the second surface section (111) onto the same plane comprises a second area.

N21. The needle (1) according to the 2 preceding embodiments, wherein a ratio between the first area and the second area is in the range of 0.1 to 10, preferably 0.2 to 5, further preferably 0.3 to 1.5, such as 0.25 to 0.75.

N22. The needle (1) according to any of the preceding embodiments, wherein the needle (1) comprises at least one transition section.

N23. The needle (1) according to the preceding embodiment, wherein the needle (1) comprises a plurality of transition sections.

N24. The needle (1) according to any of the 2 preceding embodiments, wherein the needle tip (11) comprises a surface transition section (115) connecting the first surface section (112) and the second surface section (111).

N25. The needle (1) according to any of the preceding embodiments and with the features of any of embodiments N22, and N23, wherein the needle tip (11) comprises an inner transition section (113) connecting the first surface section (112) and/or the second surface section (111) to the channel (12).

N26. The needle (1) according to the preceding embodiment and with the features of the penultimate embodiment, wherein the inner transition section (113) also connects the surface transition section (115) to the channel (12).

N27. The needle (1) according to any of the preceding embodiments, wherein the needle tip (11) further comprises an outer lateral surface (116).

N28. The needle (1) according to the preceding embodiment and with the features of any of embodiments N22, and N23, wherein the needle tip (11) comprises an outer transition section (114) connecting the first surface section (112) and/or the second surface section (111) to the outer lateral surface (116).

N29. The needle (1) according to the preceding embodiment and with the features of embodiment N24, wherein the outer transition section (114) connects the surface transition section (115) to the outer lateral surface (116).

N30. The needle (1) according to any of the preceding embodiments and with the features of any of embodiment N22, wherein any of the at least one transition section comprises a chamfer.

N31. The needle (1) according to the preceding embodiment and with the features of embodiment N25, wherein the inner transition section (113) comprises a chamfer.

N32. The needle (1) according to the preceding embodiment and with the features of embodiment N25, wherein the outer transition section (114) comprises a chamfer.

N33. The needle (1) according to any of the preceding embodiments and with the features of embodiment N22, wherein any of the at least one transition section comprises a rounding.

N34. The needle (1) according to the preceding embodiment and with the features of embodiment N25, wherein the inner transition section (113) comprises a rounding.

N35. The needle (1) according to the preceding embodiment and with the features of embodiment N25, wherein the outer transition section (114) comprises a rounding.

N36. The needle (1) according to any of the preceding embodiments, wherein the needle (1) is covered, at least in part, with a coating.

The coating may be configured to reduce an interaction between the needle and its ambient.

N37. The needle (1) according to the preceding embodiment, wherein the coating covers, at least in part, the needle tip (11).

N38. The needle (1) according to any of the 2 preceding embodiments, wherein the coating comprises a uniform coating such that a thickness of the coating is significantly identical at each coated location of the needle (1).

N39. The needle (1) according to the preceding embodiment, wherein the uniform thickness is in the range of 1.0 to 5.0 μm, preferably 2.0 to 4.0 μm, further preferably 2.5 to 3.5 μm.

N40. The needle (1) according to any of the preceding embodiments and with the features of embodiment N36, but without the features of any of the 2 preceding embodiments, wherein the coating comprises a non-uniform coating such that a thickness of the coating varies between coated locations of the needle (1).

N41. The needle (1) according to the preceding embodiment, wherein a minimum thickness of the coating is in the range of 0.1 μm to 2.0 μm, preferably 0.25 to 1 μm.

N42. The needle (1) according to any of the 2 preceding embodiments, wherein a maximum thickness of the coating is in the range of 4.0 to 7.0 μm, preferably 5.0 to 6.0 μm.

N43. The needle (1) according to any of the preceding embodiments and with the features of embodiment N37, wherein the most distal portion of the needle (1) does not comprise a coating.

N44. The needle (1) according to any of the preceding embodiments and with the features of embodiment N36, wherein the coating comprises a single material in all coated location of the needle (1).

N45. The needle (1) according to any of the preceding embodiments and with the features of embodiment N36, wherein the coating comprises a plurality of materials such that each of the plurality of materials is applied to a different portion of the needle (1).

N46. The needle (1) according to any of the preceding embodiments with the features of embodiment N36, wherein the coating comprises diamond like carbon (DLC), preferably fluorine-containing diamond like carbon (F-DLC), titanium nitride (TiN), and/or silicon carbide (SiC).

N47. The needle (1) according to any of the preceding embodiments, wherein the needle (1) is configured to detect a bottom of a container.

N48. The needle (1) according to the preceding embodiment, wherein the needle tip (11), preferably the first surface section (112) of the needle tip (11), is configured to detect the bottom of a container.

N49. The needle (1) according to any of the preceding embodiments, wherein the needle is formed of a metal, preferably a metal allow, such as stainless steel, preferably 1.4404, 1.4435, and/or 1.4571 stainless steel, M35N, or titanium, preferably titanium grade 2 or grade 5; and/or a ceramic, e.g., sapphire, ruby, and/or zirconium.

N50. The needle (1) according to any of the preceding embodiments, wherein a length (L) of the needle is in the range of 30 mm to 150 mm, preferably 50 mm to 100 mm.

N51. The needle (1) according to any of the preceding embodiments, wherein a diameter (D) of the needle is in the range of 0.1 mm to 5 mm, preferably 0.1 mm to 3 mm.

N52. The needle (1) according to any of the preceding embodiments, wherein a diameter (d) of the channel (12) is in the range of 0.05 mm to 1.0 mm, preferably 0.05 mm to 0.5 mm.

Below, apparatus embodiments will be discussed. These embodiments are abbreviated by the letter “A” followed by a number. Whenever reference is herein made to apparatus embodiments, these embodiments are meant.

A1. An apparatus comprising the needle (1) according to any of the preceding embodiments.

A2. The apparatus according to the preceding embodiment, wherein the apparatus is a sampler for liquid samples.

A3. The apparatus according to any of the preceding apparatus embodiments, wherein the apparatus is a fractioning apparatus for fractioning liquids.

Below, system embodiments will be discussed. These embodiments are abbreviated by the letter “S” followed by a number. Whenever reference is herein made to system embodiments, these embodiments are meant.

S1. An analytical system comprising the needle (1) according to any of the preceding needle embodiments or an apparatus according to any of the preceding apparatus embodiments.

S2. The analytical system according to the preceding embodiment, wherein the analytical system is a liquid chromatography system and preferably a high performance liquid chromatography system.

Below, use embodiments will be discussed. These embodiments are abbreviated by the letter “U” followed by a number. Whenever reference is herein made to use embodiments, these embodiments are meant.

U1. Use of the needle (1), the apparatus, or the system according to any of the preceding embodiments, wherein the use comprises supplying a fluid to the channel (12).

U2. The use according to the preceding embodiment, wherein the use comprises supplying the fluid with a pressure exceeding 10 bar, preferably exceeding 100 bar, further preferably exceeding 500 bar to the channel (12).

That is, the fluid in the channel may be at a pressure exceeding the above mentioned pressures.

U3. The use according to any of the preceding use embodiments, wherein the use is in an analytical procedure.

U4. The use according to the preceding embodiment, wherein the analytical procedure is liquid chromatography, and preferably high performance liquid chromatography.

### BRIEF DESCRIPTION OF DRAWINGS

Embodiments of the present technology will now be described with reference to the drawings, which should only exemplify, but not limit, the scope of the present invention.

FIG. 1a depicts a hollow needle;

FIG. 1b depicts a cross-sectional view of the hollow needle;

FIG. 2a depicts a tip of the hollow needle;

FIG. 2b depicts a cross-sectional view of the tip of the hollow needle;

FIG. 2c depicts a zoomed view of the cross-section of the tip of the hollow needle;

FIG. 3a depicts a perspective view of the tip of the hollow needle;

FIG. 3b depicts a perspective view of the cross-section of the tip of the hollow needle;

FIG. 4 depicts a fluidic structure of an autosampler;

FIG. 5a depicts a perspective view of another embodiment of a hollow needle;

FIG. 5b depicts a perspective view of a further embodiment of a hollow needle; and

FIG. 5c depicts a perspective view of a still further embodiment of a hollow needle.

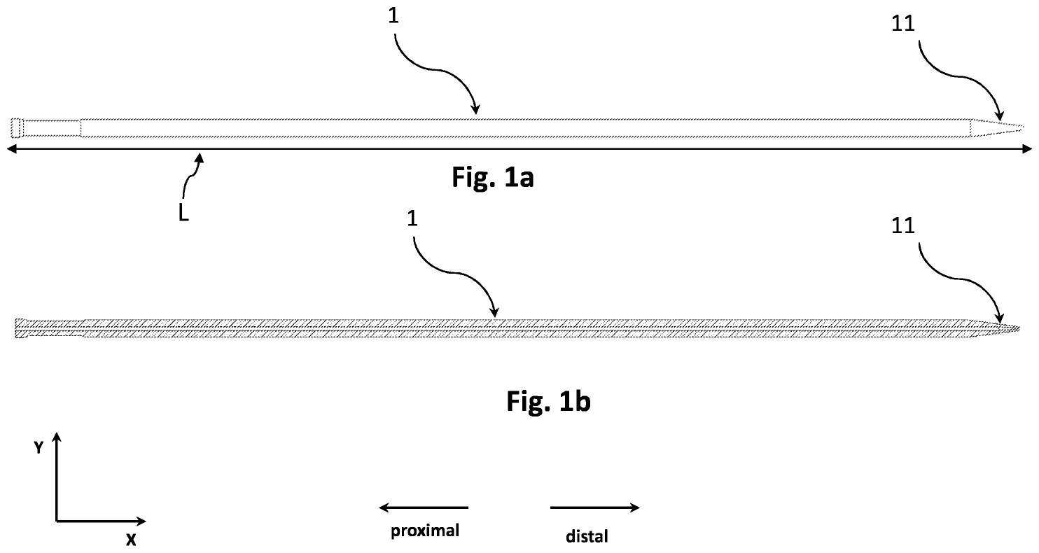

With reference to FIGS. 1a and 1b, a needle 1 is depicted. The needle 1 is generally (i.e., except for deviations of details) symmetrical and defines an axial direction, which coincides with the x-axis, which is why the axial direction is also abbreviated with x.

### DETAILED DESCRIPTIONS OF EMBODIMENTS

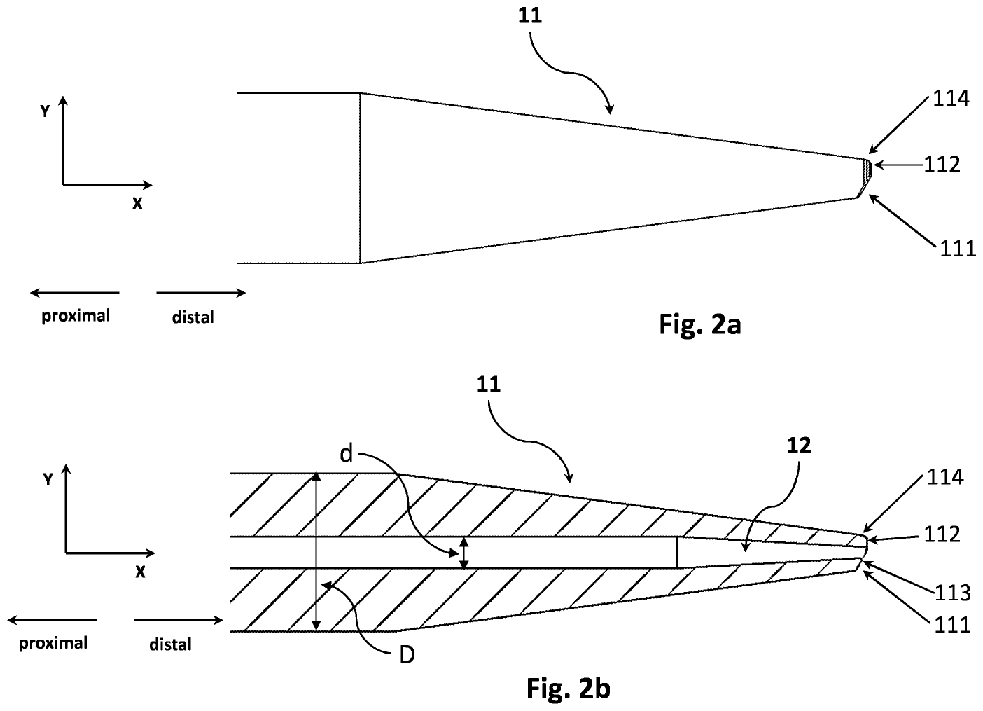

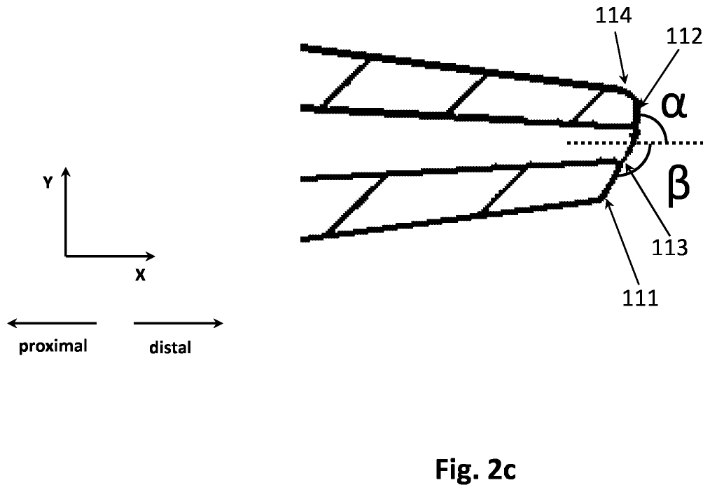

The needle 1 comprises a tip 11 at its forward end. With regard to the axial direction, a distal and a proximal direction may also be defined, wherein the distal direction indicates a portion more distal than another direction. The needle tip 11 is a distal portion of the needle 1, i.e., it is more distal than other portions, and particularly more distal than the main section of the needle 1 comprising a constant outer diameter D. The needle tip 11 generally tapers towards the distal end of the needle 1. The needle 1 may comprise a length (L) in the range of 30 mm to 150 mm, preferably in the range of 50 mm to 100 mm. Generally, the length may be long enough to reach the bottom of the deepest sample container intended for use. Furthermore, the length may be chosen to avoid the needle being bent over by the axial sealing force in the needle seat and/or cover piecing force when entering a container with cover. The needle 1 may have a section with a constant outer diameter (D), which may be in the range of 0.1 mm to 5 mm, preferably 0.1 mm to 3 mm (see FIG. 2b). Also the diameter of the needle may be chosen to avoid bending of the needle in the intended use.

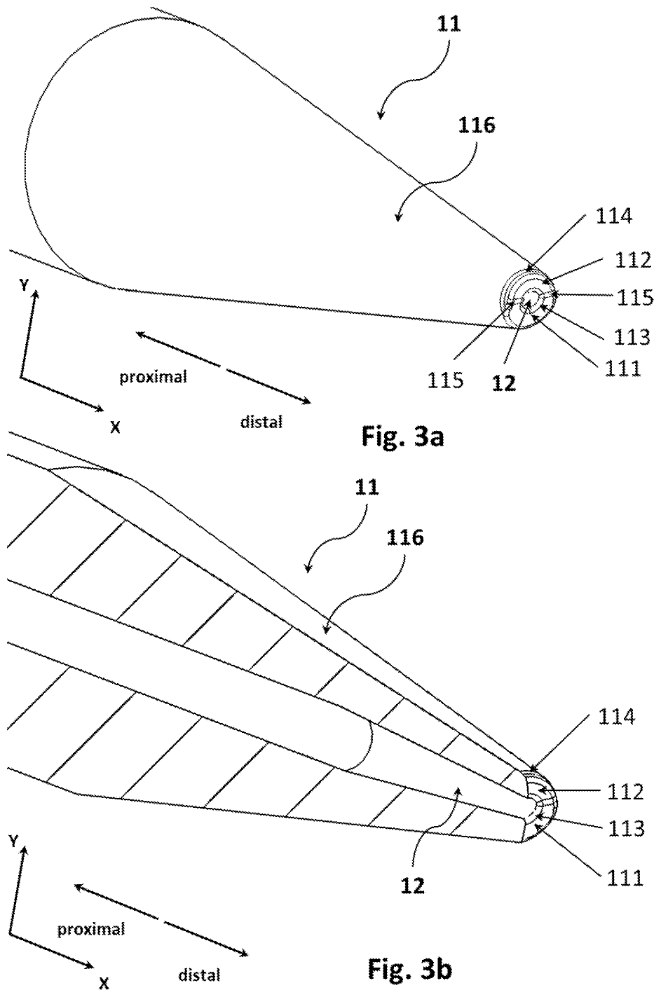

Embodiments of the present technology particularly relate to the realization of the needle tip 11, which is depicted in greater detail in FIGS. 2a to 3b.

As depicted (see, e.g., FIGS. 2a and 2b), the needle tip 11 comprises different surface sections. More particularly, the needle tip 11 comprises a first surface section 112 and a second surface section 111 that are angled with respect to one another. Put differently, as depicted in the zoom-up of the needle tip 11 in FIG. 2c, the first surface section 112 is at a first angle (α) with respect to the axial direction x, and the second surface section 111 is at a second angle (β) with respect to the axial direction, and the first angle is different to the second angle.

More particularly, the first surface section 112, is (at least substantially) orthogonal with respect to the axial direction x (i.e., α˜90°), i.e., a vector normal to the first surface section 112 (at least substantially) coincides with the axial direction x, while a normal to the second surface section 113 is more strongly angled with regard to the axial direction. For sake of simplicity, the first surface section 112 may therefore also be referred to as orthogonal surface section 112 and the second surface section 111 may be referred to as angled surface section. The first angle may be in the range of 85° to 95°, further preferably 89° to 91°, still further preferably 89.9° to 90.1°. The second angle may be in the range of 96° to 160°, preferably 100° to 140°, further preferably 110° to 120°.

As depicted, the first surface section 112 is typically the most distal (i.e., the most forward) portion of the needle 11.

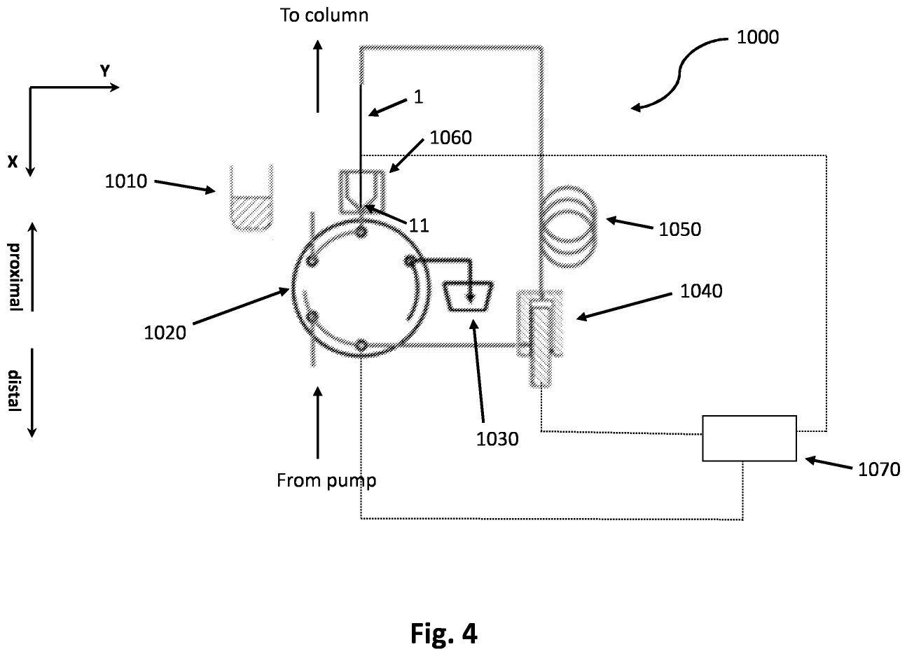

Such a needle 11 may be particularly useful, e.g., for use in high performance liquid chromatography applications. More particularly, it may be used in a sampler or a fractioning apparatus. That is, embodiments of the present technology may also relate to the field(s) of automatic sample acquisition and delivery (injection), in particular in an “autosampler” module of an analysis system. An exemplary autosampler 1000 is depicted in FIG. 4.

The autosampler 1000 may comprise a switching valve 1020, a needle seat 1060 for the needle 1, a sample storage section 1050, depicted here as a sample loop 1050, a pumping device 1040 depicted here as a metering device 1040, a sample reservoir 1010, a waste reservoir 1030, and a controller 1070 that may be configured to control the pumping device 1040, the needle 1, and the switching valve 1020. The controller 1070 can include a data processing unit and may be configured to control the system and carry out particular method steps. The controller can send and/or receive electronic signals for instructions. The controller can also be referred to as a microprocessor. The controller can be contained on an integrated-circuit chip. The controller can include a processor with memory and associated circuits. A microprocessor is a computer processor that incorporates the functions of a central processing unit on a single integrated circuit (IC), or sometimes up to a plurality of integrated circuits, such as 8 integrated circuits. The microprocessor may be a multipurpose, clock driven, register based, digital integrated circuit that accepts binary data as input, processes it according to instructions stored in its memory and provides results (also in binary form) as output. Microprocessors may contain both combinational logic and sequential digital logic. Microprocessors operate on numbers and symbols represented in the binary number system.

As depicted, the controller 1070 may be operatively coupled, to the switching valve 1020, to the pumping device 1040 and to the needle 1, and more particularly to drives (e.g., motors) of these components, and may thus control the operation of these devices

Thus, for example, a typical operation using the autosampler 1000 may comprise the controller 1070 moving the needle 1, and particularly the tip 11 of the needle 1 to pick up the sample from the sample reservoir 1010. Here, the controller 1070 may be configured to start the process of drawing up sample by pulling on a piston of the metering device 1040 (or alternatively by reducing a pressure in the fluidic channel connecting the needle 1, the sample loop 1050, and the pumping device 1040) once a bottom of the sample reservoir 1010 has been detected by the needle 1, where it will be understood that the needle 1 in the autosampler may be realized as a needle 1 as depicted in the other embodiments.

The needle 1 according to any of the embodiments described herein may then be of particular advantage with regard to bottom detection. That is, the needle 1, and more particularly the first surface section 112 may contact a bottom of the sample reservoir 1010 before picking up the sample. By means of the bottom detection, the correct predefined vertical needle tip position relative to the inner bottom of the different supported sample containers, with their different bottom thicknesses, may be ensured. Such a procedure may be particularly advantageous, as it allows (at least substantially) the complete sample in the sample container to be picked up without the risk (or with substantially reduced risk) of the needle tip 11 being damaged.

In other words, an injection process (comprising sample pick-up and delivery in an analytical system) may be performed with increased efficiency and robustness using the needle 1. This may be beneficial with regard to increased efficiency in sample collection in terms of the (amount or) volume of residual sample remaining in the sample container 1010 (for example), i.e., embodiments of the present technology may be of particular advantage with regard to collection of almost the entire sample volume without losses. This may be a consequence, in particular, of embodiments of the present technology that may also allow for detection of the inner bottom of a sample container.

Once a defined volume of fluid has been picked up by the needle 1, the controller 1070 may then move the needle 1 back into the needle seat 1060, where the picked-up fluid may be pushed into, for example, and the column as depicted in FIG. 4.

Embodiments of the present technology may thus also relate to application steps in High Performance Liquid Chromatography (HPLC). As discussed above, the needle 1 may be used in HPLC application steps, e.g., not only for sample acquisition, but also for sample delivery. The needle 1 may also be used in the process of sample fractionation (partitioning), where the described advantages may also be beneficial. The needle 1 may thus serve both to improve existing functions and to enhance existing analytical devices with new functions.

In devices such as an autosampler or a fractioning apparatus, the needle tip 11 may pierce through a septum. By having the second surface portion 111 being angled, the risk of the needle tip 11 punching out a part of the septum (which may contaminate a sample or block a channel 12 of the needle 11) may be strongly reduced.

As discussed, the (at least substantially orthogonal) first surface section 112 may define a suitable abutment surface. Thus, such a needle may abut a wall of a container holding a sample and the risk of the needle tip 11 being damaged in such a scenario is reduced with respect to a needle not having such an abutment surface resulting in high contact pressures deforming the needle tip when touching e.g. the bottom of the sample container e.g. during the bottom detection process. The channel 12 may have a diameter (d) between 0.05 mm and 1 mm, for example.

In other words, embodiments of the present technology are defined by a particular geometry of the tip 11 of the needle 1. The geometry comprises a bevel 111 (also referred to as beveled portion 111) in combination with a flat (“blunt”) end face 112, which when considered together results in a cannula/hollow needle 1 with a bevel 111 and with an end face 112 at the tip 11.

Thus, the advantages from both geometries may be combined, which include the beveled surface 111 on the one hand and the flattened/planar surface 112 on the other. The beveled surface 111 allows, e.g., a cover of a sample container to be efficiently penetrated without creating punch-outs, since deeper and irreversible penetration of the cover material into the opening 12 of the cannula/hollow needle 1 is avoided. Generally, it will be understood that opening 12 does not necessarily have to be circular. That is, the opening 12 may be circular, but it may also have another shape. The flat front surface 112 at the tip 11 of the cannula/hollow needle 1 may enable robust bottom detection/force absorption without plastic deformation and at the same time leaves enough space for the bevel 111. Put differently, the flat front surface 112 enables that a predetermined force is applied during bottom detection without greater plastic deformations, which may be critical.

The ratio of areas of the second surface section 111 and the first surface section 112 with respect to the channel (or inner opening) 12 at the tip 11 of the cannula/hollow needle 1 may be varied, and may be chosen in a particular manner depending on the intended use of the needle 1. For example, it may be chosen to get a suitable tradeoff between needle lifetime and clogging risk with a given septum. That is, the (axial) projection of the channel 12 on to a plane perpendicular to the axial direction lying within the (axial) projection (on to the same plane as the projection plane of the channel 12) of the first surface section 112 may comprise a first area, and that lying within an axial projection of the second surface section 111 on to the same plane may comprise a second area. The ratio of these first and second areas may be varied.

Preferably, the two surface sections 111, 112 may be a part of the axially projected channel 12 in equal proportions, thus allowing substantially identical flow of the sample through the first and second surface sections 111, 112, and may be contained therein at least to a minor extent. But the relative proportions may be appropriately chosen and, in embodiments, may be such that the opening of the channel 12 is comprised, for example, only in the second surface section 111. With regard to the first surface section 112, it may be advantageous to choose its proportion of the (axial projection of) channel 12 so as to ensure nearly complete/residue-free sample pick-up from a sample container.

Additionally, the ratio of the beveled surface 111 to the planar surface 112 with respect to the inner opening 12 at the tip 11 of the cannula/hollow needle 1 may be chosen in a particular manner. As can be seen, e.g., in FIGS. 3a and 3b, the channel 12 and more particular the distal opening of the channel 12 is located in both the beveled surface 111 and the flat surface 112. As depicted, e.g., in FIGS. 3a and 3b, approximately 50% of the opening may be located in the beveled surface 111 and approximately 50% may be located in the planar surface 112. However, this ratio may also be different, e.g., 90% to 10%, or 10% to 90%, or any other ration in between. The opening being partially located in the planar surface 112 and partially in the beveled surface 111 may be advantageous. More particularly, such an arrangement may also contribute to: Avoidance of punching out of the cover material of the sample container (as the opening is also in the beveled surface) and complete/residual sample collection from the sample container (as the opening is also in the planar surface).

With regard to the flat end surface 112, its proportion may be chosen to ensure complete/residue-free sample pickup from the sample container.

As depicted (see, e.g., FIGS. 3a and 3b), the needle tip 11 may also comprise a surface transition section 115 located between the first surface section 112 and the second surface section 111. Furthermore, the needle tip 11 also comprises an inner transition section 113 located between the first surface section 112 and the second surface section 111 (and the surface transition section 115 if present) on the one hand, and the channel 12 on the other hand. The inner transition section 113 may be ring shaped. The needle tip 11 may further comprise an outer transition section 114 connecting the first surface section 112 and the second surface section 111 (as well as the surface transition section 115 if present) on the one hand to an outer lateral surface 116 of the tip 11 on the other hand, where it will be understood that the outer lateral surface 116 typically tapers towards the distal direction. The outer transition section 114 may be ring shaped. The discussed transition sections 113, 114, 115 may also be referred to simply as transitions or interfaces.

In embodiments of the present invention, a tangential design may be chosen for the transitions or interfaces between the geometries of the beveled surface 111 and the flat end surface 112 and inwards to the inner opening 12 and outwards to the outer lateral surface (cone/shaft surface) at the tip 11 of the cannula/hollow needle 1. Towards the inner opening 12, one or more transitions 113 between the geometries may be provided with a curvature (not to have a sharped-edge transition) to efficiently reduce the punching out of covering material from sample containers. Also the outer transition section 114 to the outer lateral surface of the tip 11 may be chamfered or curved, e.g., in order to provide sufficient volume/space for any residual plastic deformations caused by the bottom detections and resulting material accumulations (e.g., due to bulge formation on sharp edges) at the tip 11 of the cannula/hollow needle 1 so that no damage and/or contamination is generated at contact partners.

In embodiments of the present technology, the needle 1 may be coated. That is, the needle 1 may comprise a coating layer. For example, the needle 1 may comprise a base material, e.g., MP35N, titanium (e.g., grade 2 or grade 5 titanium), stainless steel (e.g., 1.4404, 1.4435, and/or 1.4571 stainless steel), and/or a ceramic (e.g., sapphire, ruby, zirconium), and may be coated, e.g., by diamond like carbon (DLC), preferably fluorine-containing diamond like carbon (F-DLC), titanium nitride (TiN), and/or silicon carbide (SiC). However, at least a portion of the needle tip 11 may be coating free. That is, while other sections of the needle 1 may be coated, at least a portion, and more particularly a distal portion of the needle tip 11 may be non-coated.

Thus, delamination of a coating at the tip 11 of the cannula/hollow needle 1 may be prevented. In other words, the cannula/hollow needle 1 may be kept free from coating at least at a portion of the tip 11 and in particular at the flat end face 112. The directly adjacent geometries 111 and/or transitions 113, 114 thereof can also be kept free of the coating and/or provided with a gradient layer (e.g., such that the thickness of the coating increases with increasing distance from the first surface section).

To keep local areas free of coatings, a device may be used in which the cannula/hollow needle 1 is inserted during the coating process in such a way that the flat end face 112 is protected against coating layer growth, in other words, the needle is standing on surface 112 in the device. The shielding effect of the device during the coating process may provide a gradient with respect to the coating thickness, i.e. the thickness of the coating increases uniformly at the second surface section 111 with increasing distance from the first surface section 112. Again, the flat first surface section 112 may be coating free and a thickness of the coating layer may increase in the proximal direction.

The practical implementation in terms of manufacturing/production of the geometries can be carried out by any manufacturing process, preferably with grinding and/or polishing processes.

Embodiments of the invention thus relate to the combination of the geometries of the beveled surface 111 and the flat end surface 112, which allow the advantages of both geometries to be used and the respective disadvantages to be eliminated. These geometries may also be adapted such that their relations fits to each other and to the basic geometry such as the opening 12 of the cannula/hollow needle 1. This may also include the transitions between the individual geometries, such as the chamfers and roundings 113, 114 at the opening 12 and the lateral surface of the tip 11. This may allow for an improved functionality (e.g. bottom detection, residue-free sample collection).

As discussed, the flat end surface 112 on the tip 11 may also be locally free of a coating to allow tactile contact during use without damage to the components and contact partners.

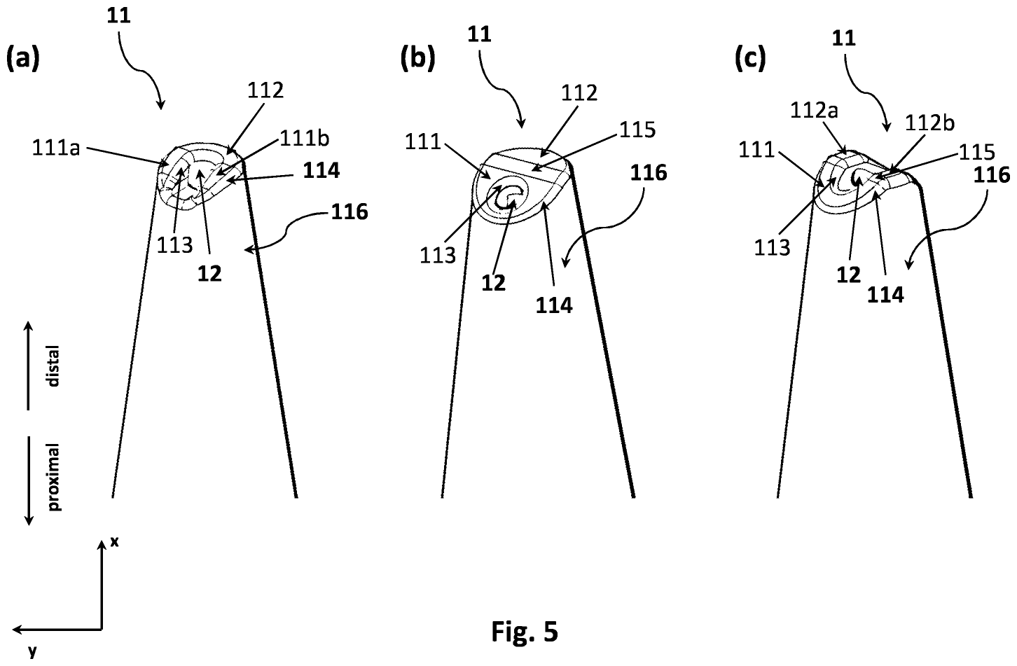

While hitherto, embodiments of the present technology have been mainly described with regard to FIGS. 1a to 3b, the skilled person will understand that this embodiment is not limiting, but that the needle tip 11 may also be realized in different manners, as exemplarily depicted in FIGS. 5a to 5c.

FIGS. 5a to 5c depict different embodiments of the needle tip 11 comprising different arrangements of the two surface sections 111, and 112. Generally, it should be understood that corresponding elements comprise corresponding reference signs throughout the drawings and that only such details will be described being different from the elements previously discussed.

In particular, FIG. 5a depicts a configuration substantially similar to that depicted in FIGS. 1 to 3, where the first surface section 112 is at a first angle (that may be such that the first surface section 112 is substantially orthogonal) to the axial direction and where the second surface section 111 is at a second angle to the axial direction, wherein the first and second angles are different from each other. Note also that the two surface sections 111, 112 may be configured such that at least part of the opening of channel 12 is accessible for fluid flow (that may, for example, be substantially parallel to the axial direction) through both the surface sections 111, 112. As depicted, in the embodiment of FIG. 5a, the second surface section 111 may comprise two single and distinct portions 111a, 111b. In particular, an embodiment as depicted in FIG. 5a may be of particular advantage in enabling bottom detection, substantially complete sample pick-up without residues. By having two (or more generally: a plurality of) single and distinct portions 111a, 111b of the second surface section 111, there may be less sharp tip portions, which may further reduce the risk of cutting off cover material.

Another exemplary embodiment of the needle tip 11 is depicted in FIG. 5b, where, in particular, the first surface section 112 is configured such that it does not allow access to channel 12. All access to channel 12 is through the second surface section 111. This configuration may be advantageous in preventing (possibly plastic) deformations of the needle tip 11 while further reducing the risk of punching out of the septum as described above, since there is no hole through the first surface section 112. Furthermore, having the access to the channel 12 completely in the second surface section 111 may further reduce the risk of cover material intrusion.

That is, embodiments of the present technology, the channel 12 and in particular a distal access to the channel 12 may coincide with the axial direction (see, e.g., FIGS. 1a to 2c, 3a, 3b, 5a and 5c). However, it is also possible that the distal access to the channel 12 does not coincide with the axial direction, as depicted in FIG. 5b.

The first surface section 112 in the embodiments described above comprise a single connected portion. However, the first surface section 112 may also comprise a plurality of distinct and non-connected portions 112a, 112b, as depicted in FIG. 5c, where it will be understood that both portions 112a, 112b are (at least substantially) at a right angle with respect to the axial direction. It should be understood that the embodiment in FIG. 5c is mirror symmetric, that is, also the second surface section 111 comprises two portions, only one of which is visible in the perspective view of FIG. 5c.

That is, with regard to the combination of the geometries, it will be understood that different arrangements and ratios of the individual geometries are possible, where similar improvements are achieved can be expected. However, all the discussed embodiments have the discussed geometries with two surface sections arranged at different angles. They may also comprise corresponding transitions/interfaces, and they also have the corresponding functions and advantages.

Overall, embodiments of the present technology are thus directed to a hollow needle/cannula, with an adaptable geometry of its tip that allows for a (at least substantially) complete and residue-free sample pick-up with a reduction in punching-out of a cover for a sample container and reduction in plastic deformation and/or material accumulation in the needle.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, preferred embodiments have been described with reference to the accompanying drawings, the skilled person will understand that these embodiments were provided for illustrative purpose only and should by no means be construed to limit the scope of the present invention, which is defined by the claims.

1. An apparatus comprising a needle (1), wherein the apparatus is a sampler for liquid samples or a fractioning apparatus for fractioning liquids,
wherein the needle (1) comprises a channel (12) extending through the needle (1),
wherein the needle (1) comprises a needle tip (11), wherein the channel (12) comprises an opening at the needle tip (11),
wherein the needle (1) defines an axial direction (x), wherein the axial direction (x) defines a distal direction and a proximal direction, wherein the needle tip (11) is a distal portion of the needle (1), and
wherein the needle tip (11) comprises a first surface section (112) and a second surface section (111), wherein the first surface section (112) is arranged at a first angle (α) with respect to the axial direction (x) and the second surface section (111) is arranged at a second angle (β) with respect to the axial direction (x), wherein the first angle is different from the second angle.

2. The apparatus according to claim 1,
wherein the first angle is in the range of 85° to 95°.

3. The apparatus according to claim 1, wherein the first surface section (112) comprises a border forming a straight line, and wherein the second surface section (111) comprises a border forming a straight line.

4. The apparatus according to claim 1, wherein the needle (1) is configured to withstand a fluid pressure exceeding 10 bar in the channel (12).

5. The apparatus according to claim 1, wherein the first surface section (112) forms a plane, wherein the opening of the channel (12) lies, at least in part, in the plane formed by the first surface section (112), wherein the second surface section (111) forms a plane, and wherein the opening of the channel (12) lies, at least in part, in the plane formed by the second surface section (111).

6. The apparatus according to claim 1, wherein the needle (1) is covered, at least in part, with a coating, wherein the coating covers, at least in part, the needle tip (11), wherein the most distal portion of the needle (1) does not comprise a coating.

7. The apparatus according to claim 6, wherein the coating comprises diamond like carbon (DLC), preferably fluorine-containing diamond like carbon (F-DLC), titanium nitride (TiN), and/or silicon carbide (SiC).

8. The apparatus according to claim 1, wherein a diameter (D) of the needle is in the range of 0.1 mm to 5 mm.

9. The apparatus according to claim 1, wherein a diameter (d) of the channel (12) is in the range of 0.05 mm to 1.0 mm.

10. An analytical system comprising the apparatus according to claim 1, wherein the analytical system is a liquid chromatography system and preferably a high performance liquid chromatography system.

11. Use of the system according to claim 10, wherein the use comprises supplying a fluid to the channel (12), wherein the use comprises supplying the fluid with a pressure exceeding 10 bar to the channel (12).
